(19) United States
(12) Patent Application Publication
(10) Pub. No.: US 2008/0055283 A1
(43) Pub. Date: Mar. 6, 2008

(54) Digital Photo Frame with Storing Functions

(76) Inventor: Juen-Tien Peng, Chung Li (TW)

Correspondence Address: HDSL, 4331 STEVENS BATTLE LANE, FAIRFAX, VA, 22033, US

(21) Appl. No.: 11/468,641

(22) Filed: Aug. 30, 2006

(51) Int. Cl. G09G 5/00

(52) U.S. Cl. 345/204

(57) ABSTRACT

A digital photo frame with storing functions includes a house, at least one storing device arranged in the house configured for storing the digital photos, at least one inserting groove arranged on a periphery of the house configured for being communicated with a memory sick, at least one peripheral hole arranged on the periphery of the house configured for being communicated with a electronic device with storing functions, a display device mounted on the peripheral of the house configured for displaying the digital photos stored in one of the storing device and the memory sick, and a processing unit arranged in the house configured for reading the digital photos stored in the memory sick and transmitting the digital photos stored in one of the storing device and the memory sick to the electronic device with storing functions.

### BACKGROUND OF THE INVENTION

1. Field of the Invention

The present invention relates to digital photo frames, and particularly to a digital photo frame with storing functions.

2. Description of the Related Art

With the development of science and technology, digital cameras substitute conventional cameras gradually since the conventional cameras need negatives which have lifetime and can only be used one time. However, photos taken by the digital cameras are electronic files and can be stored in a computer for easily being stored and managed.

The method for storing digital photos in the computer is not a good manner since the computer can be only operated by users which know some knowledge of computers. Therefore, the method cannot satisfy the users which can not operate the computer, and the computer has a high cost and a large bulk. Furthermore, the computer can be infringed by computer viruses, and if not a copy of the digital photos, the digital photos can be destroyed. Therefore, the computer is not an optimal device for storing the digital photos. Currently, a digital photo frame is utilized to substitute conventional photo frames. The digital photos can be displayed on the digital photo frame without being developed, and the displayed digital photos can be easily replaced. Compared with the computer, the digital photo frame has a thinner body, a designed shape, controllable easier operations and a lower cost. Therefore, the digital photo frame is an excellent device for storing the photos.

What is needed is to provide a digital photo frame which can overcome the above problems by using the computer.

### BRIEF SUMMARY

An objection of the present invention is providing a digital photo frame with storing functions, which includes at least one USB interface as a transmitting hole for transmitting digital photos stored in the digital photo frame to other storing devices.

Another objection of the present invention is providing a digital photo frame with storing functions, which is used as a transmitting device to be communicated with a digital camera or a memory sick for transmitting digital photos to an electronic device with storing functions, such as a portable disk, or a portable hard disk.

Still another objection of the present invention is providing a digital photo frame with storing functions, which is configured for storing digital photos to avoid data being destroyed when a computer is damaged by computer viruses.

To obtain the objections, a digital photo frame with storing functions is provided. The digital photo frame includes a house; at least one storing device arranged in the house for storing the digital photos; at least one inserting groove arranged on a periphery of the house for communicating with a memory sick; at least one peripheral contact hole arranged in the periphery of the house for communicating with an electronic device with storing functions; a display device mounted on the periphery of the house for displaying the digital photos stored in one of the storing device and the memory sick; and a processing unit arranged in the house for reading the digital photos stored in the memory sick and transmitting the digital photos stored in one of the storing device and the memory sick to the electronic device with storing functions.

The present digital photo frame can transmit the digital photos stored in the storing device and the memory sick to the electronic device with storing functions, and the step of transmitting the digital photos can be completed only be pressed down a duplicate button. Therefore, the digital photo frame of the present invention has an easy operation.

Other objects, advantages and novel features of the invention will become more apparent from the following detailed description when taken in conjunction with the accompanying drawings, in which:

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic view of a digital photo frame with storing functions in accordance with a preferred embodiment of the present invention; and

FIG. 2 is a flowing chart of a method for storing digital photos in an electronic device of FIG. 1.

### DETAILED DESCRIPTION

Reference will now be made to the drawings to describe a preferred embodiment of the present digital photo frame, in detail.

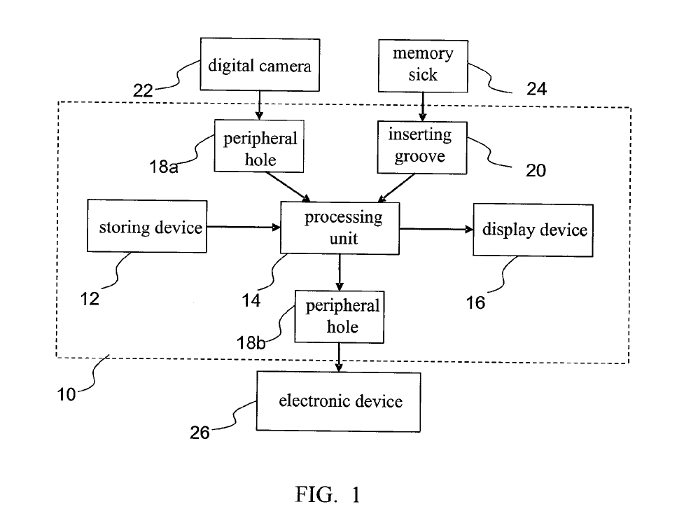

Referring to FIG. 1, a digital photo frame 10 with storing functions in accordance with a preferred embodiment of the present invention is shown. The digital photo frame 10 includes a storing device 12, a processing unit 14, a display device 16, at least one peripheral hole 18 and an inserting groove 20. The storing device 12 and the processing unit 14 are arranged in the digital photo frame 10. The display device 16, the peripheral hole 18 and the inserting groove 20 are arranged on a periphery of a house of the digital photo frame 10. The storing device 12 is a memory configured for storing digital photos. The processing unit 14 is configured for process the digital photos. The display device 16 displays the digital photos processed by the processing unit 14. The peripheral hole 18 is communicated with a digital camera 22 or other electronic devices, such as a portable hard disk, a portable disk, or a computer, to be configured for storing the digital photos. The inserting groove 20 is configured for being communicated with a memory stick 24 having the digital photos stored therein.

In this embodiment, the peripheral hole 18 is an USB interface, and the peripheral hole 18 includes a peripheral hole 18a and a peripheral hole 18b. After the peripheral hole 18b is communicated with an electronic device 26 with storing functions, such as the portable hard disk, the portable disk, or the computer, the digital photos stored in the storing device 12 can be transmitted to the electronic device 26 with storing functions. The digital camera 22 may be communicated directly with the peripheral hole 18a of the digital photo frame 10 with storing functions for transmitting the digital photos to the electronic device 26 via the peripheral hole 18a, the processing unit 14 and the peripheral hole 18b. Furthermore, in this embodiment, the inserting groove 20 arranged on the digital photo frame 10 with storing functions, is communicated with the memory stick 24 for transmitting the digital photos stored in the memory stick 24 to the electronic device 26 via the digital photo frame 10.

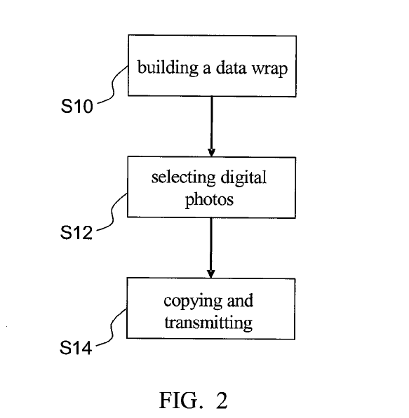

In this embodiment, the method for storing the digital photos has a simple model and a ladder model. Referring to FIG. 2, a method for storing the digital photos is shown. In a step S10, a data folder is built in the electronic device 26 with storing functions. The data folder is a photo album, and the data folder can be named as a date of building the data folder in the simple model and be named a name by users in the ladder model. In a step S12, the digital photos to be stored are selected. In the simple model, it is only able to store all the digital photos, but in the ladder model the digital photos selected by the users can be stored. In a step S14, the digital photos being selected or all the digital photos are copied and transmitted to the electronic device 26 via the peripheral hole 18b by pressing down a duplicate button mounted on the digital photo frame 10.

The present digital photo frame 10 utilizes the plurality of peripheral holes to communicate the digital camera or the memory sick directly with the digital photo frame for transmitting the digital photos to the electronic device, such as portable disk, portable hard disk to avoiding dangers of losing data when the computer is damaged by computer viruses.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A digital photo frame with storing functions, comprising:
a house;
at least one storing device arranged in the house for storing the digital photos;
at least one inserting groove arranged on a periphery of the house for being communicated with a memory sick;
at least one peripheral hole arranged on the periphery of the house for being communicated with an electronic device with storing functions;
a display device mounted on the peripheral of the house for displaying the digital photos stored in one of the storing device and the memory sick; and
a processing unit arranged in the house for reading the digital photos stored in the memory sick and transmitting the digital photos stored in one of the storing device and the memory sick to the electronic device with storing functions.

2. The digital photo frame as claimed in claim 1, wherein the display device is a liquid crystal display screen.

3. The digital photo frame as claimed in claim 1, wherein the at least one peripheral hole and a transmitting interface of the electronic device are USB interfaces.

4. The digital photo frame as claimed in claim 1, wherein the at least one peripheral hole is communicated with the electronic device and a digital camera to transmit the digital photos stored in the digital camera to the electronic device.

5. The digital photo frame as claimed in claim 4, wherein the processing unit stores the digital photos to the electronic device in one of a simple model and a ladder model.

6. The digital photo frame as claimed in claim 5, wherein the simple model is a data folder being built in the electronic device by the processing unit and copying all the digital photos to the data folder.

7. The digital photo frame as claimed in claim 6, wherein a name of the data folder is a date of building the data folder.

8. The digital photo frame as claimed in claim 6, father comprising a duplicate button mounted on the digital photo frame, when the duplicate button being pressed down, all the digital photos are copied and transmitted to the electronic device.

9. The digital photo frame as claimed in claim 5, wherein the ladder model is a data folder being built in the electronic device by the processing unit and copying the digital photos selected by an user to the data folder.

10. The digital photo frame as claimed in claim 9, wherein the name of the data folder is defined by the user.

11. The digital photo frame as claimed in claim 9, father comprising a duplicate button mounted on the digital photo frame, when the duplicate button being pressed down, the digital photos selected by the user are copied and transmitted to the electronic device.

12. The digital photo frame as claimed in claim 1, wherein the electronic device is selected from a group consisting of a computer, a hard disk and a portable disk.
